(19) United States
(12) Patent Application Publication
(10) Pub. No.: US 2002/0120560 A1
(43) Pub. Date: Aug. 29, 2002

(54) System for pricing a payment protection product and method of operation thereof

(76) Inventor: Richard L. Morgan, Dallas, TX (US)

Correspondence Address: Jimmy L. Heisz, Hitt Gaines & Boisbrun, P.C., P.O. Box 832570, Richardson, TX, 75083, US

(21) Appl. No.: 09/795,176

(22) Filed: Feb. 26, 2001

(51) Int. Cl. G06F 17/60

(52) U.S. Cl. 705/38; 705/4

(57) ABSTRACT

A payment protection product pricing system and method of operating the same. In one embodiment the system provides for a family support obligation module that gathers legal information regarding a family support obligation of a payor. Associated with the family support obligation module is a consumer credit assessment module that analyzes the legal information and assesses a credit rating of the payor relative thereto.

### TECHNICAL FIELD OF THE INVENTION

The present invention is directed, in general, to protection products and, more specifically, to a system for pricing a payment protection product for a family support obligation and a method of operating the same.

### BACKGROUND OF THE INVENTION

The problem caused by certain parents who, for a variety of reasons, fail to provide resources for the support of their children although they have the economic means and a court has ordered them to do so, has attracted the attention of a number of governmental entities. In many cases a child not supported by its natural parents must be supported under a government funded program. This means funds, otherwise available for other purposes, are being utilized to undertake the personal obligation of the child's parent. This is one reason a number of states have implemented programs to collect unpaid child support from “deadbeat” parents.

The failure of a parent to act responsibly in supporting his or her child is frequently found in the context of a divorce case. A divorced custodial parent relies, in large part, on payments from the non-custodial parent to provide for the child. Paternity cases requiring child support are also fraught with a high default rate.

The requirement to make child support payments is usually set forth in a court judgment or decree. In the case of a divorce, the judgement or decree may merely be the ratification of a mutually agreed upon marital settlement agreement or contract. In the case of a paternity suit, the judgement to pay child support is frequently the reason the suit was instituted in the first place. The child support judgment or decree typically requires a noncustodial parent to make periodic payments to a custodial parent. The payments will usually be for a specified dollar amount and cover a specific period of time. For example, a judgement or decree may require a non-custodial parent to pay the custodial parent $600 a month until the child reaches the age of eighteen. Notwithstanding a legal obligation of the non-custodial parent to make such payments, the rate of default is enormous.

One difficulty in enforcing an obligation to make child support payments is that the parents frequently live in different jurisdictions. The mobility of people in the United States makes it common for the custodial parent to live in one state, such as Texas, and the non-custodial parent to live in another, such as California. This not only makes it difficult to locate a defaulting non-custodial parent, it also makes enforcement difficult. Although collection problems caused by differing jurisdictional collection laws are largely addressed by the Uniform Child Support and Collection Act and various other related statutes, it can still be relatively expensive to enforce a judgement, particularly when the custodial parent's funds are limited. If child support is not collected, the custodial parent continues to incur an unfair burden of providing the sole support for the child, notwithstanding the ability of the non-custodial parent to pay.

One way to address collection difficulties and alleviate the hardship potential for a custodial parent, is to issue a financial product that provides for the continued payment of child support, even if the non-custodial parent defaults. Such a product could be in the form of an insurance policy, bond, corporate guarantee, or other similar instrument. One problem in issuing such a product in a family support situation, is pricing the product.

Accordingly, what is needed in the art is a system to price a financial product for undertaking the assurance that a family support obligation will be paid and a method of operating the same.

### SUMMARY OF THE INVENTION

To address the above-discussed deficiencies of the prior art, the present invention provides a payment protection product pricing system and method of operating the same. In one embodiment, the system provides for a family support obligation module that gathers legal information regarding a family support obligation of a payor. Associated with the family support obligation module is a consumer credit assessment module that analyzes the legal information and assesses a credit rating of the payor relative thereto.

The present invention provides a system for determining the price of a payment protection product to be issued that assures the continued payment of a family support obligation, even if the person obligated to make such payments defaults. The payment protection product may take the form of an insurance policy, bond, corporate guarantee, or other financial product. If the product is an insurance policy, for example, it may contain typical insurance limits, such as specifying that payments are limited to a percentage of the payor's obligation, requiring a waiting period before payments commence, and limiting the number of payments made. In most cases, such a product will be issued to the custodial parent to assure the continued receipt of child support payments if the non-custodial parent defaults. In most cases, the payor will be required to purchase the product at the time a divorce decree is entered or a judgment is entered in a paternity suit. Of course, the invention is intended to cover any similar financial product, whether now known or developed at a later date, that involves a family support obligation.

One embodiment of the invention provides for the system to gather legal information regarding the child support payment obligation of the payor. Another aspect of the system provides for the legal information included in the family support obligation module to include information selected from the group consisting of a statute, a court decree, and a contract.

In another embodiment of the invention, the consumer credit assessment module includes credit information regarding the payor. In still another embodiment, the consumer credit assessment module includes a credit rating assessment tool. These embodiments are particularly beneficial for assigning a credit rating to a payor that can be used to determine a price to charge for the payment protection product. These embodiments are advantageous because, by assigning a credit rating to a payor, the risk of a payment default can be estimated based on the historical default rates of consumers with similar credit ratings on obligations such as automobile or home loans.

Another useful embodiment of the invention provides for the consumer credit assessment module to assign a recognized standard consumer credit score to the payor. Such standard consumer credit ratings are a well recognized prior art method of assigning creditworthiness scores to debtors. The standard consumer credit score can then be used to predict the probability that a payor will meet his or her financial obligation. In yet still another embodiment, a consumer credit comparison module compares the payor's credit rating with consumer debt payment default characteristics of other types of consumer debt of debtors having credit ratings similar to the obligor.

In another embodiment of the invention, a computer network is associated with the family support obligation module and the consumer credit assessment module. Such a network permits access to the system by multiple parties, such as attorneys, court officials, and state collection officials.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a system, constructed in accordance with the principles of the present invention, for pricing a payment protection product for a family support obligation;

FIG. 2 illustrates a block diagram of an embodiment of a method of operating a system for pricing a payment protection product for a family support obligation;

FIG. 3 illustrates a typical general-purpose computer system of a type that can be used with the invention;

FIG. 4 illustrates a block diagram showing the basic functional components of a computer of the type illustrated in FIG. 3; and

FIG. 5 illustrates a block diagram of an embodiment of a computer network of a type with which the present invention could be used.

### DETAILED DESCRIPTION

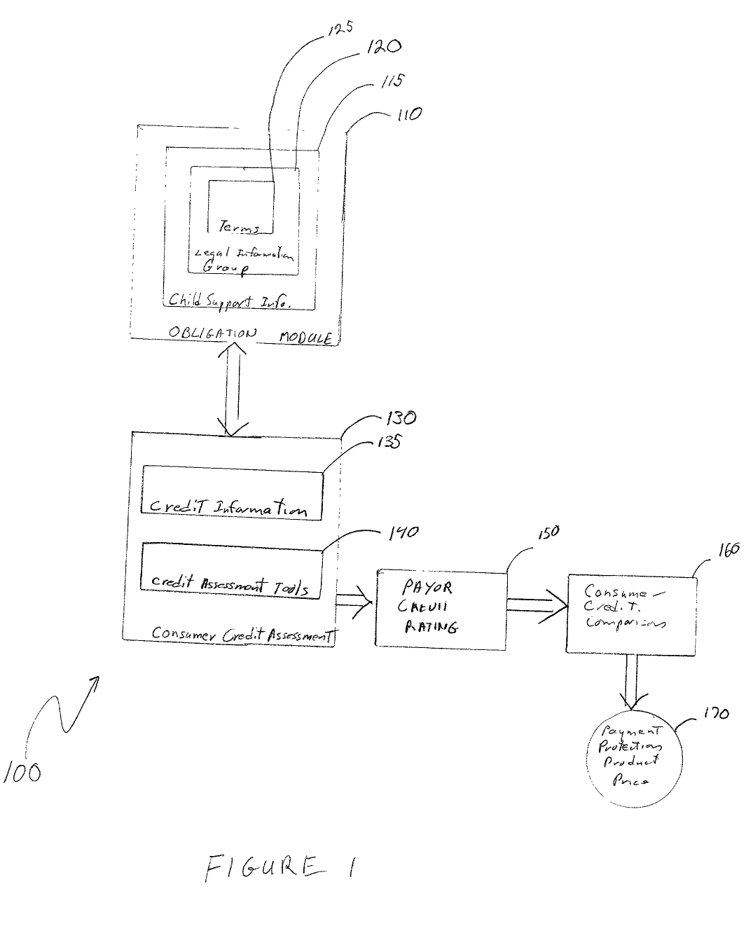

Referring initially to FIG. 1, illustrated is a block diagram of an embodiment of a system 100, constructed in accordance with the principles of the present invention, for pricing a payment protection product for a family support obligation. The illustrated embodiment of the system 100 includes a family support obligation module 110 that gathers legal information regarding a payor's family support obligation.

The illustrated invention is particularly useful when the relevant family support obligation is an obligation to pay child support. Therefore, the illustrated embodiment provides for the system 100 to be used in pricing a payment protection product for a child support obligation. Thus, the family support obligation module 110 gathers and includes child support information 115 regarding a payor's obligation to make child support payments.

In one embodiment of the invention the system 100 the legal information regarding a family support obligation is selected from a group 120 consisting of a statute, a court decree or a contract. The embodiment illustrated in FIG. 1, provides for such legal information to be selected from such a group 120 regarding a child support obligation of a payor. In another embodiment of the invention the family support obligation module 110 provides for inclusion of the terms 125 relative to the payor's family support obligation to pay child support. Typically, the terms 125 will provide for periodic payments of certain sums of money over a specified period of time. Of course the inclusion of additional or other provisions in the terms 125, such as the obligation to provide health insurance for the child or an obligation to pay college expenses, is well within the intended scope of the invention.

The embodiment illustrated in FIG. 1, thus illustrates a family support obligation module 110 that gathers legal information regarding child support 115. The module 110 includes terms 125 regarding a payor's obligation to pay. Such terms 125 may be embodied in a statute (such as a state law regarding a requirement of a parent to pay for the support of a child), or a court decree (such as a decree entered into in connection with a divorce or a paternity suit), or in a contract (such as an agreement entered into by the custodial and non-custodial parent incident to a divorce).

Those of ordinary skill in the pertinent art will understand that the invention is intended to cover any type of information that can be embodied in the family support obligation module 110 that addresses the family support obligation of a payor. The family support obligation module 110 can thus, for example, include specific terms and conditions embodied in a statute, rule or regulation of a governmental entity. It can also include information regarding enforcement and collection data, all of which will be within the intended scope of the present invention. Distinctions between the collection and enforcement laws of various jurisdictions can also be included, whether presently in force or subsequently enacted. The family support obligation module 110 can also include appropriate provisions regarding the Federal Uniform Child Support and Collection Act, which is important in ultimately determining a price for a payment protection product involving a child support obligation.

Associated with the family support obligation module 110 is a consumer credit assessment module 130. The consumer credit assessment module 130 analyzes the legal information 115 and assesses, relative thereto, the payor's credit rating. In one embodiment, the consumer credit assessment module 130 includes credit information 135 regarding the payor. Such credit information 135 would include such information as the payor's net worth, earnings history, previous debt payment history, and such other factors that are important in assessing a credit rating. In another embodiment of the invention, the consumer credit assessment module 130 includes a credit assessment tool 140. One useful tool 140 develops a standard consumer credit score for a payor. The standard consumer credit score assigned to a payor can be used to ascertain the risk of issuing a payment protection product to secure a payor's family support obligation.

The consumer credit assessment module 130, in association with the family support obligation module 110, analyzes the legal information 120 to assess a credit rating 150 of the payor. In one embodiment, a consumer credit comparison module 160 compares the payor's credit score to the commercially published credit ratings of other consumers having other types of consumer debt, such as automobile and home loans, and with the payment and default characteristics of such consumers with respect to such other types of consumer debt. The payment and default characteristics for consumers with credit ratings similar to the payor are then used to price a payment protection product 170. Those of ordinary skill in the pertinent art will understand that the system 100 is intended to cover any type of payment protection product, although most frequently such products will typically take the form of an insurance policy, performance bond, or corporate guarantee.

Another embodiment of the system 100 (hereinafter illustrated and described) provides for a computer network to be associated with the family support obligation module 110 and consumer credit assessment module 130. This embodiment is useful because the computer network or networks, as the case may be, can be made accessible to a number of interested parties. For example, all the various attorneys involved, court officials, and government agencies involved in a particular family support matter can access the system to participate or review information.

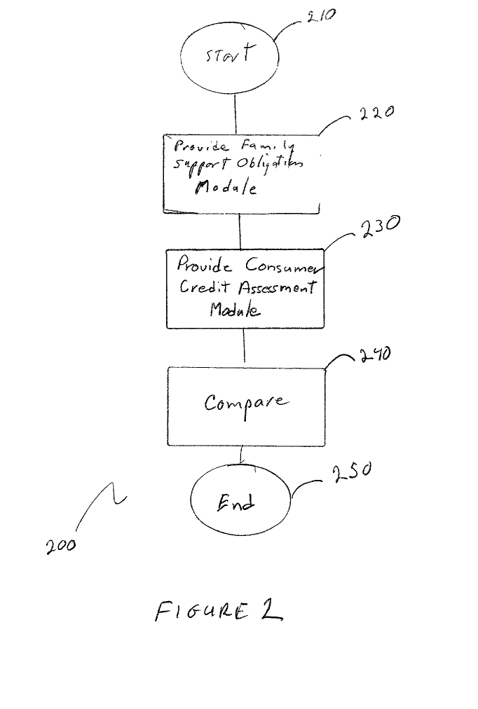

Turning now to FIG. 2, illustrated is a block diagram of an embodiment of a method 200 of operating a system for pricing a payment protection product for a family support obligation. The method 200 commences with a start 210 step. In a provide family support obligation module 220 step, legal information regarding a family support obligation of a payor is gathered in a database. The module can then be programed to perform predetermined tasks with the legal information in accordance with specified sequencing parameters. In one embodiment of the invention, the provide family support obligation module 220 step includes providing information regarding a payor's obligation to provide child support. In another, the provide family support obligation module 220 step includes providing legal information from a group consisting of a statute, a court decree, and a contract.

In a provide consumer credit assessment module 230 step, a consumer credit assessment module is provided and associated with the family support obligation module. The consumer credit assessment module analyzes the legal information and assesses a payor's credit rating relative thereto. In another embodiment, in a compare step 240, a consumer credit comparison module compares the payor's credit score rating to other debtors credit scores relative to debt payment and default chacteristics for other types of consumer debt. One embodiment of the invention provides for credit information regarding the payor to be included in the consumer credit assessment module. In still another embodiment, a credit rating assessment tool is included in the consumer credit assessment module. In yet another embodiment, the consumer credit assessment module assigns a standard consumer credit score to the payor. In still another embodiment, a computer network step is associated with the family support obligation module and the consumer credit assessment module. The illustrated method concludes with an end step 250.

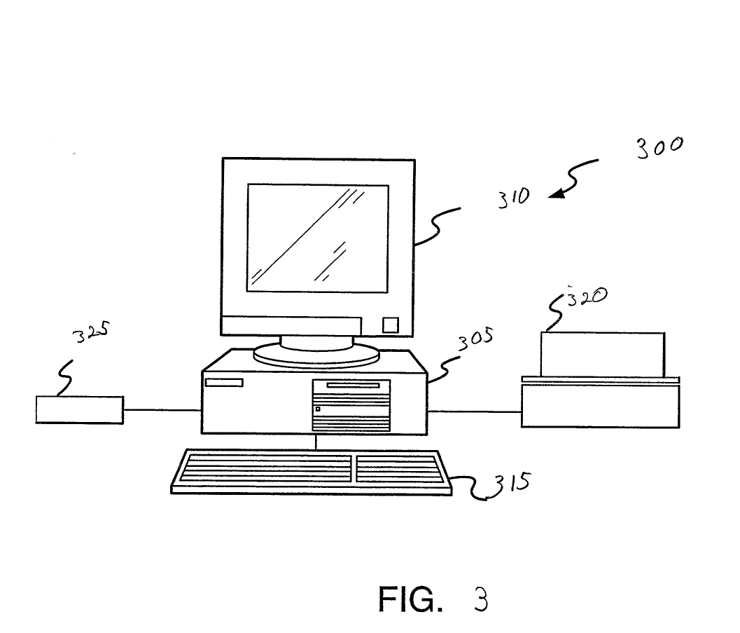

Turning now to FIG. 3, illustrated is a typical general-purpose computer system 300 of a type that can be used with the invention. Those of ordinary skill in the pertinent art will understand that the invention described herein will constitute a program for a computer using computer programming language appropriate to the computer for which the program is prepared.

The computer system 300 has a computer 305, a monitor 310, a keyboard 315, a printer 320 and a modem 325 for use with a telephone line. The computer 305 contains all of the elements required to use and operate the appropriate software to run the invention described herein. The monitor 310 allows the results and interactions of the computer 305 to be displayed for interpretation by the user. The keyboard 315 allows the user to interact with the computer 305, and the printer 320 provides for the generation of hard copy files related to the invention. The modem 325 allows data and information to be interchanged with other sites via the phone lines. For example, a lawyer in one city may have a need to coordinate a family support matter with lawyer in another city, such as collecting past due child support from a defaulting payor. The information that would permit such a collection action to proceed can be readily entered into a central computer 305 and transmitted over telephone lines by using a modem 325 as soon as the location of the defaulting payor is ascertained.

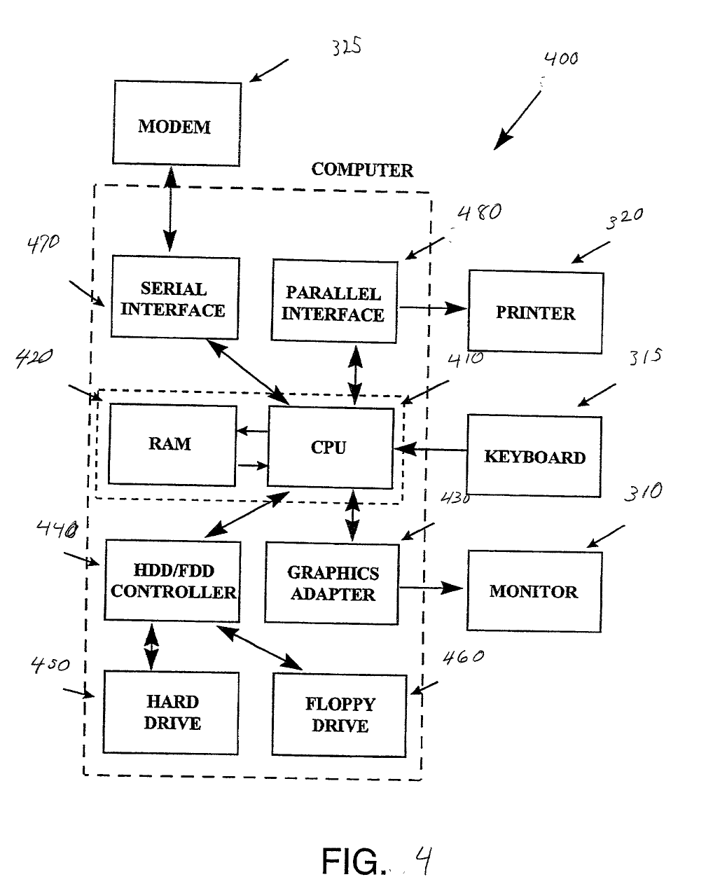

Turning now to FIG. 4 illustrated is a block diagram showing the basic functional components of a computer 400 of the type illustrated in FIG. 3. The computer 400 is illustrated as having a central processing unit (“CPU”) 410, random access memory (“RAM”) 420, a graphics adapter 430, a hard disk drive/floppy disk drive (“HDD/FDD”) controller 440, a hard disk drive 450, a floppy disk drive 460, a serial interface 470 and a parallel interface 480. The CPU 410 is the “heart” of the computer 400 and is where the processing takes place. The CPU 410 is connected directly to the keyboard (315 of FIG. 3) from which it receives data or commands. The RAM 420 is used to store or read the immediate results of the data processing or software program execution and is a fast memory element which may also contain software elements for processor instruction execution.

The graphics adaptor 430 accepts data from the CPU 410 and translates it so that it may be displayed on the monitor (310 of FIG. 3). The HDD/FDD controller 440 is used to read and write data from both the hard disk drive 450 and the floppy disk drive 460, which provide for longer term storage. The parallel interface 480 allows for parallel transfer of data, and is generally a faster way to communicate data than the serial interface 470, which may also be known as a communications interface. The parallel interface 480 typically drives the printer (320 of FIG. 3) as shown, while the serial interface 470 typically allows data interchange with other systems via the phone lines through the modem (325 of FIG. 3).

The present invention may be advantageously embodied as a sequence of software instructions executable on the computer system (300 of FIG. 3) that will be used to create the invention in all its various embodiments and carry out the methods of operating the system as set forth herein. Those skilled in the art will recognize that the present invention may alternatively be embodied in hard-wired discrete or integrated circuitry or in analog circuitry.

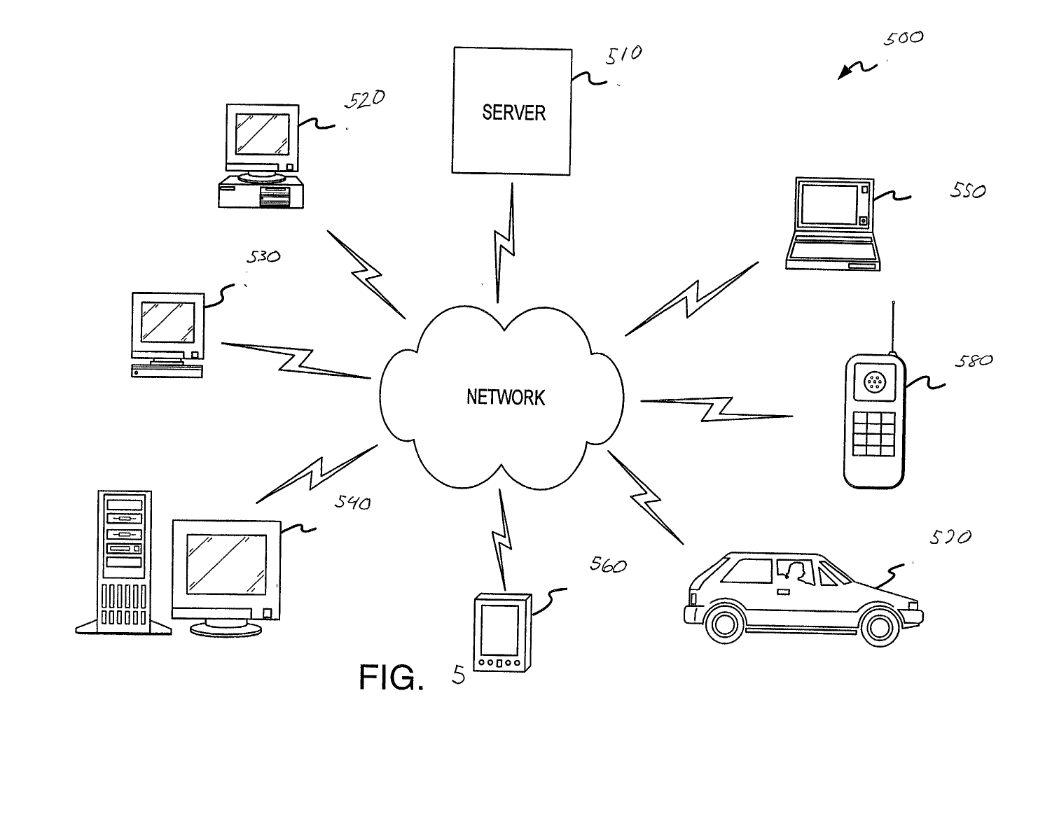

Turning now to FIG. 5 illustrated is a block diagram of an embodiment of a computer network 500 of a type with which the present invention could be used. As indicated previously with respect to FIG. 1, in one embodiment of the invention, the system 100 provides for a computer network 500, such as the type illustrated, to be associated with the family support obligation module 110 and the consumer credit assessment module 120. A computer network 500 is a valuable aspect of the invention because the system 100 can be accessed by a number of different parties located in differing geographic locations. For example, the system 100 may be accessed by the parties attorneys, court officials, and governmental agencies that have an interest in a specific family support obligation.

A computer network 500 of the type illustrated can be configured to distribute, collect and process information among all the involved parties so they all have access to the invention described herein. The computer network 500 may include a Local Area Network (“LAN”), a Wide Area Network (“WAN”), an Intranet, an Extranet, the Internet, the World Wide Web or a combination thereof. An Intranet is a private network contained within an enterprise (such as a law firm with multiple offices) and may consist of interlinked LANs and leased lines in a WAN. Typically, an Intranet includes connections through one or more gateway computers (not shown) to the outside Internet. The main purpose of an Intranet is to share information and computing resources and, in some instances, to facilitate working in groups. An Extranet is a private network that uses the Internet protocols and the public telecommunication system to securely share part of an enterprise's information or operations with other enterprises. An Extranet can be viewed as part of an enterprise's Intranet that is extended to outside users.

Within the typical environment of the computer network 500 is a server 510 that includes systems allowing the server 510 to receive requests, perform specific tasks, retrieve and update information in at least one database and respond to requests sent over the computer network 500 to the server 510. In some cases the computer network 500 may include multiple servers 510, each performing specific tasks, performing the same tasks, acting as redundant systems or acting as database sites.

The computer network 500 may also include one or several interface devices, such as a conventional personal computer (“PC”) 520, a conventional workstation 530, a conventional office computer system 540 and a conventional laptop computer 550. In other embodiments, the computer network 500 may include a number of PCs 520, workstations 530, office computer systems 540 and laptop computers 550. The computer network 500 can also include personal digital assistants (“PDA”) 560 or small mobile hand-held devices that provide computer functions, information storage and retrieval capabilities for personal or business use. An individually addressable vehicle (“IAV”) 570 can also be within the computer network 500. An IAV 570 may include any instrument capable of having computer functions combined with a wireless receiver and/or transmitter that is individually addressable. For example, a car containing an Internet terminal is an IAV 570.

A mobile telephone 580 may also be included in a computer network 500. The mobile telephone 580 can include a display capable of showing information retrievable from the computer network 500. The mobile telephone 580 can send and retrieve information from the server 510 and perform specialized tasks associated with the capabilities of a mobile telephone with network capabilities.

Although the present invention has been described in detail, those skilled in the art should understand that they can make various changes, substitutions and alterations herein without departing from the spirit and scope of the invention in its broadest form.

What is claimed is:

1. A system for pricing a payment protection product, comprising:
a family support obligation module that gathers legal information regarding a family support obligation of a payor; and
a consumer credit assessment module, associated with said family support obligation module, that analyzes said legal information and assesses a credit rating of said payor relative thereto.

2. The system as recited in claim 1 wherein said legal information includes a child support payment obligation of said payor.

3. The system as recited in claim 1 wherein said legal information is selected from the group consisting of:
a statute,
a court decree, and
a contract.

4. The system as recited in claim 1 wherein said consumer assessment module includes credit inform ation regarding said payor.

5. The system as recited in claim 1 wherein said consumer assessment module includes a credit rating assessment tool.

6. The system as recited in claim 1 wherein said consumer credit assessment module assigns a standard consumer credit score to said payor.

7. The system as recited in claim 6 further comprising a consumer credit comparison module comparing said payor's credit score rating to other debtors credit scores relative to debt payment and default chacteristics for other types of consumer debt.

8. The system as recited in claim 1 further comprising a computer network associated with said family support obligation module and said consumer credit assessment module.

9. A method of operating a system for pricing a payment protection product, comprising:
providing a family support obligation module that gathers legal information regarding a family support obligation of a payor; and
providing a consumer credit assessment module, associated with said family support obligation module, that analyzes said legal information and assesses a credit rating of said payor relative thereto.

10. The method as recited in claim 9 wherein said legal information includes child support payment obligation of said payor.

11. The method as recited in claim 9 wherein said legal information is selected from the group consisting of:
a statute,
a court decree, and
a contract.

12. The method as recited in claim 9 wherein said consumer assessment module includes credit information regarding said payor.

13. The method as recited in claim 9 wherein said consumer assessment module includes a credit rating assessment tool.

14. The method as recited in claim 9 wherein said consumer credit assessment module assigns a standard consumer credit score to said payor.

15. The method as recited in claim 14 further comprising a consumer credit comparison module comparing said payor's credit score rating to other debtors credit scores relative to debt payment and default chacteristics for other types of consumer debt.

16. The method as recited in claim 9 further comprising providing a computer network associated with said family support obligation module and said consumer credit assessment module.

17. An online payment protection product pricing system, comprising:
an Internet site;
a family support obligation module associated with said Internet site that gathers legal information regarding a family support obligation of a payor; and
a consumer credit assessment module, associated with said family support obligation module, that analyzes said legal information and assesses a credit rating of said payor relative thereto.

18. The system as recited in claim 17 wherein said legal information includes a child support payment obligation of said payor.

19. The system as recited in claim 17 wherein said legal information is selected from the group consisting of:
a statute,
a court decree, and
a contract.

20. The system as recited in claim 17 wherein said consumer assessment module includes credit information regarding said payor.

21. The system as recited in claim 17 wherein said consumer assessment module includes a credit rating assessment tool.

22. The system as recited in claim 17 wherein said consumer credit assessment module assigns a standard consumer credit score to said payor.

23. The system as recited in claim 22 further comprising a consumer credit comparison module comparing said payor's credit score rating to other debtors credit scores relative to debt payment and default chacteristics for other types of consumer debt.

24. The system as recited in claim 17 wherein said Internet site is further comprising of a computer network associated with said family support obligation module and said consumer credit assessment module.
